(19) United States
(12) Patent Application Publication
(10) Pub. No.: US 2024/0352193 A1
(43) Pub. Date: Oct. 24, 2024

(54) POLYAMIC ACID AQUEOUS SOLUTION COMPOSITION

(71) Applicant: KOREA RESEARCH INSTITUTE OF CHEMICAL TECHNOLOGY, Daejeon (KR)

(72) Inventors: Jong Chan WON, Daejeon (KR); Yun Ho KIM, Daejeon (KR); No Kyun PARK, Daejeon (KR); Yu Jin SO, Daejeon (KR); Jin Soo KIM, Daejeon (KR); Jong Min PARK, Busan (KR); Sung Mi YOO, Daejeon (KR); Hyun Jin PARK, Daejeon (KR); Hyun Jeong AHN, Daejeon (KR); Jin Ha HA, Daejeon (KR); Sun Kyu KIM, Daejeon (KR); Hyo Eun LEE, Daegu (KR); Eun Byeol SEO, Daejeon (KR); Eun Bee CHO, Daejeon (KR); Kyung Eun KIM, Daejeon (KR)

(21) Appl. No.: 18/575,726

(22) PCT Filed: May 27, 2022
(86) PCT No.: PCT/KR2022/007610

§ 371 Date: Dec. 29, 2023

(30) Foreign Application Priority Data
Jun. 29, 2021 (KR) 10-2021-0084725

(51) Int. Cl. C08G 73/10

(52) U.S. Cl. CPC C08G 73/1039

(57) ABSTRACT

The present application provides a polyamic acid aqueous solution composition prepared of a polyimide, wherein the composition enables the polymerization of hydrophobic-based monomers into a polyamic acid in water and is improved in transparency, eco-friendliness, storage stability, and the like when cured.

### CROSS-REFERENCE TO RELATED APPLICATION

The present application claims the benefit of Korean Patent Application No. 10-2021-0084725, filed on Jun. 29, 2021 in the Korean Intellectual Property Office, the disclosure of which is incorporated herein by reference.

### TECHNICAL FIELD

The present application relates to an aqueous polyamic acid composition.

### BACKGROUND ART

With the advent of the 5G mobile communication and Internet of Things (IoT) era, as multifunctional, miniaturized, and highly integrated functional materials are required, polyimide polymers are attracting attention as highly heat-resistant materials for electrical and electronic applications.

Polyimide is a polymer material with high thermal stability, has excellent mechanical strength, chemical resistance, weather resistance, and heat resistance, and has physical property stability over a wide range of temperatures (−273° C. to 400° C.). In particular, its use in the electronics and optical fields is increasing because it has electrical insulation, flexibility, and non-flammability.

Typically, polyimide synthesis is obtained by dehydrating polyamic acid obtained by polycondensation of an aromatic dianhydride and an aromatic diamine in an organic solvent. This synthetic process may not be easy to perform due to the hydrolysis of the aromatic dianhydride, which is vulnerable to moisture, during polycondensation in a solvent. For this reason, the main problems with the polyamic acid synthesized in an organic system are molecular weight control and controlling the crosslinking reaction due to the initial fast reaction, and the problem of contamination from the organic solvent used and the expensive processing costs to solve this problem still need to be solved.

Meanwhile, when polymerizing polyamic acid in water, the dispersibility of the hydrophobic aromatic dianhydride and aromatic diamine, was poor, making polymerization difficult.

### DISCLOSURE

### Technical Problem

The present application provides an aqueous polyamic acid composition, which enables the polymerization of polyamic acid from hydrophobic monomers in water and may be used to prepare a polyimide with improved transparency, eco-friendliness, and storage stability upon curing.

### Technical Solution

The present application relates to an aqueous polyamic acid composition.

An exemplary aqueous polyamic acid composition includes polyamic acid including a diamine monomer and a dianhydride monomer as polymerization units; an aqueous mixed solvent including water and a polar solvent and having a surface tension of 50 mN/m or less; and an aqueous catalyst. As the composition of the present application includes an aqueous mixed solvent whose surface tension is adjusted within the above range, it is possible to enable aqueous polymerization of the polyamic acid by improving the dispersibility of hydrophobic monomers and provide a polyimide having improved transparency, environmental friendliness, and storage stability upon curing. The surface tension can be adjusted to the above range by appropriately selecting the mixing ratio of water and a polar solvent depending on the type of polar solvent. The surface tension may be measured using a known method at room temperature, for example, 25° C.

In one example, the aqueous catalyst may have a surface tension of 35 mN/m or less, 34 mN/m or less, 33 mN/m or less, 32 mN/m or less, 31 mN/m or less, 30 mN/m or less, 29 mN/m or less, 28 mN/m or less, 27 mN/m or less, 26 mN/m or less, or 25 mN/m or less. By adjusting the surface tension of the aqueous catalyst within the above range, aqueous polymerization of polyamic acid with hydrophobic monomers, for example, fluorine-based monomers, is possible.

In one embodiment, the polar solvent may have at least one polar functional group selected from the group consisting of a hydroxyl group, a carboxyl group, an alkoxy group, an ester group, an ether group, and a nitrile group. In the present application, the surface tension of the aqueous mixed solvent may be adjusted within the above-mentioned range by appropriately designing the mixing ratio of water and the polar solvent according to the type and number of polar functional groups.

More specifically, the polar solvent may include ethanol, 1-propanol, isopropanol, tetrahydrofuran, or acetonitrile.

In one embodiment, the polar solvent may be included in an amount of 10% by weight or more based on the total content of the aqueous mixed solvent. For example, the lower limit of the content of the polar solvent may be 11% by weight or more, 12% by weight or more, 13% by weight or more, 14% by weight or more, 15% by weight or more, 20% by weight or more, 25% by weight or more, 30% by weight or more, 35% by weight or more, 40% by weight or more, or 45% by weight or more. The upper limit of the content of the polar solvent may be 99% by weight or less, 90% by weight or less, 85% by weight or less, 80% by weight or less, 75% by weight or less, 70% by weight or less, 65% by weight or less, 60% by weight or less, 55% by weight or less, or 50% by weight or less.

FIG. 1 is a graph showing the surface tension of an aqueous mixed solvent according to the content (% by weight) of various polar solvents. Referring to FIG. 1, the surface tension tends to decrease as the content of the polar solvent increases with respect to the total content of the aqueous mixed solvent, and the rate of decrease varies depending on the type and number of polar functional groups. Considering this point, in the present application, the surface tension of the aqueous mixed solvent may be adjusted within the above-mentioned range by adjusting the content of the polar solvent.

In one example, the weight ratio of water and the polar solvent in the aqueous mixed solvent may range from 1:1 to 9:1, and the molar ratio of water and the polar solvent may range from 1:1 to 9.5:0.5. The weight or molar ratio of water and the polar solvent may be appropriately selected within the above range in consideration of the type of polar solvent so that the surface tension of the aqueous mixed solvent is within the above-mentioned range.

As described above, the composition of the present application includes the aqueous mixed solvent whose surface tension is adjusted to a specific numerical range, so that aqueous polymerization of fluorine-based monomers may be possible. For example, the diamine monomer and dianhydride monomer may each have an alkyl group substituted with at least one fluorine as a substituent.

In one example, the aqueous catalyst may be a pyridine derivative compound or a tertiary amine having at least one substituent. In the present application, uniform polymerization of polyamic acid in water is possible by using the pyridine derivative compound or tertiary amine having at least one substituent as an aqueous catalyst.

In one example, the pyridine derivative compound may satisfy Chemical Formula 1 below:

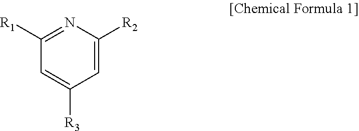

in Chemical Formula 1, at least one of R₁ to R₃ is an alkylamine group, a hydroxyl group, an alkoxy group, a thiol group, a thiol ether group, an alkyl group, or a heterocyclic group, and preferably at least one of R₁ to R₃ is an alkylamine group having 1 to 4 carbon atoms, a hydroxy group, an alkoxy group having 1 to 4 carbon atoms, a thiol group, a thiol ether group having 1 to 4 carbon atoms, an alkyl group having 1 to 4 carbon atoms, or a heterocyclic group.

In addition, when one or two of R₁ to R₃ are substituents defined above, the remainder may represent hydrogen.

Examples of the pyridine derivative compound satisfying Chemical Formula 1 may include 4-(methylamino)pyridine, 4-(dimethylamino)pyridine, 2-hydroxypyridine, 4-hydroxypyridine, 4-methoxypyridine, 2-methoxypyridine, 2,6-dimethoxypyridine, 2-ethoxypyridine, 4-mercaptopyridine, 2-mercaptopyridine, 4-(methylthio)pyridine, 2-(methylthio)pyridine, 4-methylpyridine, 2-methylpyridine, 4-ethylpyridine, 2-ethylpyridine, 4-propylpyridine, 2,4,6-trimethylpyridine, 4-piperidinopyridine, 4-morpholinopyridine, or 4-pyrrolidinopyridine.

In another example, the pyridine derivative compound may satisfy Chemical Formula 2 below:

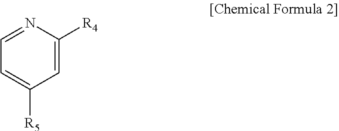

in Chemical Formula 2, at least one of R₄ and R₅ is a monoalkylamino group having 1 to 4 carbon atoms, a dialkylamino group having 1 to 4 carbon atoms, a hydroxyl group, an alkoxy group having 1 to 4 carbon atoms, a thiol group, a thiol ether group having 1 to 4 carbon atoms, an alkyl group having 1 to 4 carbon atoms, a piperidino group, a morpholino group, or a pyrrolidino group, and preferably a monoalkylamino group having 1 to 4 carbon atoms, a dialkylamino group having 1 to 4 carbon atoms, a piperidino group, a morpholino group, or a pyrrolidino group.

In an embodiment of the present application, examples of the pyridine derivative compound satisfying Chemical Formula 2 may be 4-(dimethylamino)pyridine, 2-(dimethylamino)pyridine, 4-(methylamino)pyridine, 4-piperidinopyridine, 4-morpholinopyridine, or 4-pyrrolidinopyridine.

As another example, the tertiary amine having at least one substituent may satisfy Chemical Formula 3 below:

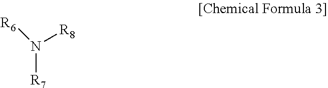

in Chemical Formula 3, R₆ to R₈ are a substituted or unsubstituted alkyl group, preferably a substituted or unsubstituted alkyl group having 1 to 10 carbon atoms,
at least one of R₆ to R₈ is a substituted alkyl group, and
the substituted alkyl group includes at least one substituent selected from the group consisting of cyano (or nitrile), a halogen, hydroxy, alkoxy, thiol, sulfide, sulfoxide, alkylamide, phosphate, carboxy, carbonyl, and ester.

In the present application, uniform polymerization of polyamic acid in water is possible by using an aqueous catalyst that satisfies Chemical Formula 3 as described above, in particular, as the aqueous catalyst forms a salt with a carboxyl group of polyamic acid, imidization of polyamic acid is possible even when cured at a relatively low temperature of 200° C.

When the substituent is cyano (—CN), the compound of Chemical Formula 3 may be 3-methylaminopropionitrile (DMAPN), 4-methylaminobutyronitrile, 3-(dimethylamino)-2-methylpropanenitrile, 3-(diethylamino) propionitrile, or 3-[ethyl(methyl)amino]propanenitrile, and when the substituent is a halogen (—Cl or —Br), the compound may be 2-chloroethyldimethylamine, or 2-bromoethyldimethylamine, (2-bromoethyl) (ethyl)methylamine, but is not limited thereto.

In addition, when the substituent is hydroxy (—OH), the compound of Chemical Formula 3 may be 2-(dimethylamino) ethanol, and when the substituent is alkoxy (—OR), the compound may be 2-methoxy-N,N-dimethylethanamine, but is not limited thereto.

In addition, when the substituent is thiol (—SH), the compound of Chemical Formula 3 may be N,N-diethylcysteamine, when the substituent is sulfide (—SR), the compound may be N,N-dimethyl-2-(methylsulfonyl) ethanamine, and when the substituent is sulfoxide (—SOR), the compound may be (2-(diethylamino)ethyl) ethanethioate, but is not limited thereto.

In addition, when the substituent is alkylamide (—CONHR), the compound of Chemical Formula 3 may be N-[2-(dimethylamino)ethyl]acetamide, and when the substituent is phosphate (—POOOHOH), the compound may be demanyl phosphate, but is not limited thereto.

In addition, when the substituent is carboxy (—COOH), the compound of Chemical Formula 3 may be 3-(dimethylamino) propionic acid, when the substituent is carbonyl (—COR), the compound may be 4-(dimethylamino)butan-2-one, and when the substituent is ester (—COOR), the compound may be methyl 3-(dimethylamino)propanoethyl or dimethylaminoethyl acetate, but is not limited thereto.

In an embodiment of the present application, the aqueous catalyst may be in the range of 0.1 to 2 times equivalent, or 0.5 to 1.5 times equivalent, based on 1 equivalent of the carboxyl group in polyamic acid. In one example, the aqueous catalyst may be 0.55 times equivalent or more, 0.6 times equivalent or more, 0.7 times equivalent or more, 0.8 times equivalent or more, 0.83 times equivalent or more, or 0.93 times equivalent or more, based on 1 equivalent of the carboxyl group in the polyamic acid, and, the upper limit may be 1.8 times equivalent or less, 1.6 times equivalent or less, 1.4 times equivalent or less, or 1.3 times equivalent or less.

In the present specification, “equivalent based on carboxyl groups in polyamic acid,” which defines the amount of the aqueous catalyst, may mean the number (number of moles) of the aqueous catalyst used for one carboxyl group in polyamic acid.

In one specific example, the polyamic acid composition may include 1 to 50% by weight, for example, 1 to 45% by weight, 2 to 40% by weight, or 3 to 35% by weight of a solid content, based on the total weight of the polyamic acid composition. In the present application, by controlling the solid content of the polyamic acid composition, it is possible to prevent an increase in manufacturing costs and process time, which is caused by removing a large amount of solvent during a curing process, while controlling an increase in viscosity.

In the present specification, the terms “polyamic acid composition,” “polyamic acid solution,” “aqueous polyamic acid composition,” and “polyimide precursor composition” may be used with the same meaning. In addition, in the present specification, the terms “curing” and “imidization” may be used with the same meaning.

The dianhydride monomer that may be used to prepare the polyamic acid solution may be an aromatic tetracarboxylic dianhydride. For example, the dianhydride monomer includes at least one compound represented by Chemical Formula 4 below:

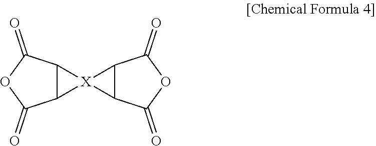

in Chemical Formula 4, X is a substituted or unsubstituted tetravalent aliphatic ring group, a substituted or unsubstituted tetravalent heteroaliphatic ring group, a substituted or unsubstituted tetravalent aromatic ring group, or a substituted or unsubstituted tetravalent heteroaromatic ring group, and the aliphatic ring group, the heteroaliphatic ring group, the aromatic ring group, or the heteroaromatic ring group is present singly; joined together to form a condensed ring; or linked by a linking group including one or more of divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)₂—, and —Si(Rₐ)₂—, wherein Rₐ is hydrogen or an alkyl group.

Preferably, X is phenyl, biphenyl,

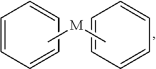

or an aliphatic ring group, M includes at least one selected from the group consisting of a single bond, an alkylene group, an alkylidene group, —O—, —S—, —C(═O)—, and —S(═O)₂—, and is substituted with at least one substituent including fluorine and an alkyl group or unsubstituted. When X in Chemical Formula 4 is

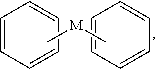

M may be an alkylene group having at least one fluorine-substituted alkyl group as a substituent. As an example, an at least one fluorine-substituted alkyl group having 1 to 6 carbon atoms may be a perfluoroalkyl group, and specifically, may be a perfluoromethyl group. In another example, the dianhydride monomer component may include at least one dianhydride monomer substituted with at least one fluorine.

In the present specification, the term “aliphatic ring group” may mean an aliphatic ring group having 3 to 30 carbon atoms, 4 to 25 carbon atoms, 5 to 20 carbon atoms, and 6 to 16 carbon atoms, unless otherwise specified. Specific examples of a tetravalent aliphatic ring group may include groups obtained by removing four hydrogen atoms from a ring, such as a cyclohexane ring, a cycloheptane ring, a cyclodecane ring, a cyclododecane ring, a norbornane ring, an isobornane ring, an adamantane ring, and a dicyclopentane ring.

In the present specification, the term “aromatic ring group” may mean an aromatic ring group having 4 to 30 carbon atoms, 5 to 25 carbon atoms, 5 to 20 carbon atoms, and 6 to 16 carbon atoms, unless otherwise specified, and the aromatic ring may be a monocyclic ring or a condensed ring. Examples of the tetravalent aromatic hydrocarbon ring group include groups obtained by removing four hydrogen atoms from a benzene ring, a naphthalene ring, an anthracene ring, a phenanthrene ring, a perylene ring, a tetracene ring, or a pyrene ring.

In the present specification, the term “arylene group” may mean a divalent organic group derived from an aromatic ring group.

In the present specification, the term “heterocyclic group” includes a heteroaliphatic ring group and a heteroaromatic ring group.

In the present specification, the term “heteroaliphatic ring group” may refer to a ring group in which at least one of the carbon atoms of the aliphatic ring group is replaced with one or more heteroatoms selected from the group consisting of nitrogen, oxygen, sulfur, and phosphorus.

In the present specification, the term “heteroaromatic ring group” may refer to a ring group in which at least one of the carbon atoms of the aromatic ring group is replaced with one or more heteroatoms selected from the group consisting of nitrogen, oxygen, sulfur, and phosphorus, unless otherwise specified. The heteroaromatic ring group may be a monocyclic ring or a condensed ring.

The aliphatic ring group, the heteroaliphatic ring group, the aromatic ring group, or the heteroaromatic ring group may each independently substituted with one or more substituents selected from the group consisting of halogen, a hydroxyl group, a carboxyl group, a halogen-substituted or unsubstituted alkyl group having 1 to 4 carbon atoms, and an alkoxy group having 1 to 4 carbon atoms.

In the present specification, the term “single bond” may mean a bond linking both atoms without any atoms. For example, when X in Chemical Formula 4 is

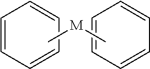

and M is a single bond, both aromatic rings may be directly linked to each other.

In the present specification, the term “alkyl group” may mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may have a linear, branched or cyclic structure and may be optionally substituted with one or more substituents. The substituent may be, for example, a polar functional group such as one or more substituents consisting of a halogen, a hydroxyl group, an alkoxy group, a thiol group, or a thiol ether group.

In the present specification, the term “alkenyl group” may mean an alkenyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkenyl group may have a linear, branched or cyclic structure and may be optionally substituted with one or more substituents. The substituent may be, for example, a polar functional group such as one or more substituents consisting of a halogen, a hydroxyl group, an alkoxy group, a thiol group, or a thiol ether group.

In the present specification, the term “alkynyl group” may mean an alkynyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkynyl group may have a linear, branched or cyclic structure and may be optionally substituted with one or more substituents. The substituent may be, for example, a polar functional group such as one or more substituents consisting of a halogen, a hydroxyl group, an alkoxy group, a thiol group, or a thiol ether group.

In the present specification, the term “alkylene group” may mean an alkylene group having 2 to 30 carbon atoms, 2 to 25 carbon atoms, 2 to 20 carbon atoms, 2 to 16 carbon atoms, 2 to 12 carbon atoms, 2 to 10 carbon atoms, or 2 to 8 carbon atoms, unless otherwise specified. The alkylene group is a divalent organic group in which two hydrogens are removed from different carbon atoms, may have a linear, branched or cyclic structure, and may be optionally substituted with one or more substituents. The substituent may be, for example, a polar functional group such as one or more substituents consisting of a halogen, a hydroxyl group, an alkoxy group, a thiol group, or a thiol ether group.

In the present specification, the term “alkylidene group” may mean an alkylidene group having 1 to 30 carbon atoms, 1 to 25 carbon atoms, 1 to 20 carbon atoms, 1 to 16 carbon atoms, 1 to 12 carbon atoms, 1 to 10 carbon atoms, or 1 to 8 carbon atoms, unless otherwise specified. The alkylidene group is a divalent organic group in which two hydrogens are removed from one carbon atom, and may have a linear, branched or cyclic structure and may be optionally substituted with one or more substituents. The substituent may be, for example, a polar functional group such as one or more substituents consisting of a halogen, a hydroxyl group, an alkoxy group, a thiol group, or a thiol ether group.

In the present specification, the term “alkoxy group” may mean an alkoxy group having 1 to 30 carbon atoms, 1 to 25 carbon atoms, 1 to 20 carbon atoms, 2 to 16 carbon atoms, 1 to 12 carbon atoms, 1 to 8 carbon atoms, or 1 to 4 carbon atoms, unless otherwise specified. The alkoxy group may have a linear, branched or cyclic alkyl group, and the alkyl group may be optionally substituted with one or more substituents. The substituent may be, for example, one or more substituents consisting of a halogen, a hydroxyl group, an alkoxy group, a thiol group, or a thiol ether group.

In the present specification, the term “alkylamine group” includes a monoalkylamine (—NHR) or dialkylamine (—NR₂), where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

In the present specification, the term “alkylamide” includes a monoalkylamide (—C(O)NHR) or dialkylamide (—C(O)NR₂), where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

In the present specification, the term “thiol ether group” or “sulfide” means-SR, where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

In the present specification, the term “sulfoxide” means —S(O)R, where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

In the present specification, the term “carbonyl” includes-C(O)R, where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

In the present specification, the term “ester” includes —C(O)OR or —OC(O)R, where R may each independently mean an alkyl group having 1 to 30 carbon atoms, 1 to 25 carbon atoms, 1 to 20 carbon atoms, 1 to 16 carbon atoms, 1 to 12 carbon atoms, 1 to 8 carbon atoms, or 1 to 4 carbon atoms, unless otherwise specified. The alkyl group may be a linear, branched or cyclic alkyl group and may be optionally substituted with one or more substituents. The substituent may be, for example, one or more substituents consisting of a halogen, a hydroxyl group, an alkoxy group, a thiol group, or a thiol ether group.

Examples of the aliphatic tetracarboxylic dianhydride satisfying Chemical Formula 4 may include 1,2,4,5-cyclohexane tetracarboxylic dianhydride (or HPMDA), bicyclo[2.2.2]octane-2,3,5,6-tetracarboxylic 2:3,5:6-dianhydride (BODA), 1,2,3,4-cyclohexane tetracarboxylic dianhydride (CHMDA), bicyclo[2.2.1]heptane-2,3,5,6-tetracarboxylic 2:3,5:6-dianhydride (BHDA), butane-1,2,3,4-tetracarboxylic dianhydride (BTD), bicyclo-[2.2.2]oct-7-ene-2-exo,3-exo,5-exo,6-exo-2,3:5,6-dianhydride (BTA), 1,2,3,4-cyclobutane tetracarboxylic dianhydride (CBDA), bicyclo[4.2.0]octane-3,4,7,8-tetracarboxylic dianhydride (OTD), norbonane-2-spiro-α-cyclohexanone-α′-spiro-2″-norbonane-5,5″,6,6″-tetracarboxylic dianhydride (ChODA), cyclopentanone bis-spironorbonane tetracarboxylic dianhydride (CpODA), bicyclo[2.2.1]heptane-2,3,5-tricarboxyl-5-acetic dianhydride (BSDA), dicyclohexyl-3,3′,4,4′-tetracarboxylic dianhydride (DCDA), dicyclohexyl-2,3′3,4′-tetracarboxylic dianhydride (HBPDA), 5,5′-oxybis(hexahydro-1,3-isobenzofurandione) (HODPA), 5,5′-methylenebis(hexahydro-1,3-isobenzofurandione) (HMDPA), 3,3′-(1,4-piperazine-diyl)bis[dihydro-2,5-furandione](PDSA), 5-(2,5-dioxotetrahydrofurfuryl)-3-methyl-3-cyclohexane-1,2-dicarboxylic anhydride (DOCDA), 3,4-dicarboxy-1,2,3,4-tetrahydro-1-naphthalene succinic dianhydride (TDA), 3,4-dicarboxy-1,2,3,4-tetrahydro-6-methyl-1-naphthalene succinic dianhydride (MTDA), 3,4-dicarboxy-1,2,3,4-tetrahydro-6-fluoro-1-naphthalene succinic dianhydride (FTDA), 3,3,3′,3′-tetramethyl-1,1′-spirobisindan-5,5′,6,6′-tetracarboxylic anhydride (SBIDA), 4,4,4′,4′-tetramethyl-3,3′,4,4′-tetrahydro-2,2′-spirobi[furo[3,4-g]chromene]-6,6′,8,8′-tetraone (SBCDA), and 9,10-difluoro-9,10-bis(trifluoromethyl)-9,10-dihydroanthracene-2,3,6,7-tetracarboxylic acid dianhydride (8FDA).

Aromatic tetracarboxylic dianhydrides satisfying Chemical Formula 4 may include, but are not limited to, pyromellitic dianhydride (or PMDA), 3,3′,4,4′-biphenyltetracarboxylic dianhydride (or BPDA), 2,3,3′,4′-biphenyltetracarboxylic dianhydride (or a-BPDA), oxydiphthalic dianhydride (or ODPA), diphenylsulfone-3,4,3′,4′-tetracarboxylic dianhydride (or DSDA), bis(3,4-dicarboxyphenyl) sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (or BTDA), bis(3,4-dicarboxyphenyl) methane dianhydride, 2,2-bis(3,4-dicarboxyphenyl) propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy) biphenyl dianhydride, 2,2-bis[(3,4-dicarboxyphenoxy)phenyl]propane dianhydride (BPADA), 2,3,6,7-naphthalenetetracarboxylic dianhydride, 1,4,5,8-naphthalenetetracarboxylic dianhydride, and 4,4′-(2,2-hexafluoroisopropylidene)diphthalic dianhydride (6-FDA).

In addition, the diamine monomer that can be used to prepare the polyamic acid solution is a fluorine-based aromatic diamine, and the diamine monomer may include at least one compound represented by Chemical Formula 5 below:

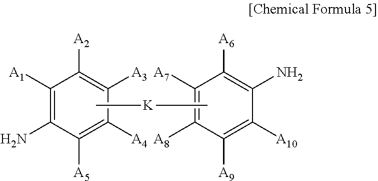

in Chemical Formula 5, K is a linking group including one or more of divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)₂—, and —Si(Rₐ)₂—, and wherein A₁ to A₁₀ each independently represent hydrogen; a halogen; a hydroxyl group; a carboxyl group; or an alkyl group substituted with a halogen or unsubstituted, and
at least one of K and A₁ to A₁₀ has an alkyl group substituted with fluorine in its structure.

As another example, the diamine monomer may include at least one compound represented by Chemical Formula 6 below:

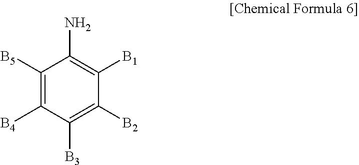

in Chemical Formula 6, any one of B₁ to B₅ is an amino group, and the others are hydrogen; a halogen; a hydroxyl group; a carboxyl group; or a halogen-substituted or unsubstituted alkyl group, and
at least one of B₁ to B₅ has an alkyl group substituted with fluorine in its structure. Preferably, any one of B₁ to B₅ is an amino group, and the others have an alkyl group substituted with hydrogen or fluorine as a substituent.

As the present application includes an aqueous mixed solvent that satisfies the specific surface tension described above, for example, aqueous polymerization of fluorine-based monomers may be possible. In the present application, “fluorine-based monomer” may mean a monomer having an alkyl group substituted with fluorine as a substituent.

The polyamic acid composition of the present application may be a composition having a low viscosity characteristic. The polyamic acid composition of the present application may have a viscosity of 20,000 cps or less, 15,000 cps or less, 13,000 cps or less, 12,000 cps or less, 11,000 cps or less, 10,000 cps or less, or 6,000 cps or less, as measured at a temperature of 25° C. and a shear rate of 30 s⁻¹. The lower limit is not particularly limited, but may be 10 cP or more, 15 cP or more, 30 cP or more, 100 cP or more, 300 cP or more, 500 cP or more, or 1,000 cP or more. The viscosity may be measured, for example, using VT-550 manufactured by Haake GmbH, and may be measured at a shear rate of 30/s, a temperature of 25° C., and a plate gap of 1 mm. The present application can provide a precursor composition having excellent processability by adjusting the viscosity range.

In one example, the polyamic acid composition may have an inherent viscosity of 0.1 or more, 0.2 or more, or 0.3 or more, as measured at a temperature of 30° C. and a concentration of 0.5 g/100 mL (dissolved in water) based on its solid content. The upper limit is not particularly limited, but may be 5 or less, 3 or less, 2 or less, 1.5 or less, or 1 or less. In the present application, by controlling the inherent viscosity, it is possible to adjust the molecular weight of polyamic acid to an appropriate amount and ensure processability.

In one embodiment, the polyamic acid composition of the present application may have a weight average molecular weight ranging from 10,000 to 200,000 g/mol, 15,000 to 80,000 g/mol, 18,000 to 70,000 g/mol, 20,000 to 60,000 g/mol, 25,000 to 55,000 g/mol, or 30,000 to 50,000 g/mol after curing. In the present application, the term “weight average molecular weight” means a conversion value with respect to standard polystyrene as measured by gel permeation chromatography (GPC).

When the aqueous polyamic acid composition of the present application is prepared as a cured product, the cured product satisfies various physical properties described below and may exhibit excellent physical properties such as mechanical strength and heat resistance. In the present application, the cured product of the aqueous polyamic acid composition refers to polyimide.

In one example, the cured product of the aqueous polyamic acid composition may have a light transmittance to visible light in the range of 80% to 99%. For example, the lower limit of the light transmittance may be 85% or more, 86% or more, 87% or more, 88% or more, 89% or more, 90% or more, or 91% or more, and the upper limit of the light transmittance may be 99% or less, 98% or less, 97% or less, 96% or less, 95% or less, 94% or less, or 93% or less.

In another example, the cured product of the aqueous polyamic acid composition may have a yellowness in the range of 0.5 to 2.5. The lower limit of the yellowness may be 0.6 or more, 0.7 or more, 0.8 or more, 0.9 or more, 1.0 or more, 1.1 or more, 1.2 or more, 1.3 or more, or 1.4 or more, and the upper limit of the yellowness may be 2.4 or less, 2.3 or less, 2.2 or less, 2.1 or less, 2.0 or less, 1.9 or less, 1.8 or less, 1.7 or less, and 1.6 or less.

In addition, the cured product of the aqueous polyamic acid composition may have a glass transition temperature in the range of 200 to 450° C. For example, the lower limit of the glass transition temperature is 210° C. or more, 220° C. or more, 230° C. or more, 240° C. or more, 250° C. or more, 260° C. or more, 270° C. or more, 280° C. or more, 290° C. or more, or 300° C. or more, and the upper limit of the glass transition temperature may be 440° C. or less, 430° C. or less, 420° C. or less, 410° C. or less, 400° C. or less, 390° C. or less, 380° C. or less, 370° C. or less, 360° C. or less, or 350° C. or less.

The present application also relates to a method of preparing polyamic acid. In one example, a method for preparing the aqueous polyamic acid composition may include preparing polyamic acid using an aqueous mixed solvent including a mixture of water and a polar solvent and having a surface tension of 50 mN/m or less; and an aqueous catalyst. The preparation method of the present application may prepare a polyamic acid that may provide a polyimide with improved transparency, eco-friendliness, storage stability, and the like upon curing by using the aqueous mixed solvent and the aqueous catalyst. For example, the polyamic acid may be prepared through the polymerization reaction of fluorine-based monomers.

The present application relates to a method of preparing a polyimide. The polyimide preparing method includes preparing polyamic acid using an aqueous mixed solvent including a mixture of water and a polar solvent and having a surface tension of 50 mN/m or less; and an aqueous catalyst; and preparing polyimide by heat curing the polyamic acid at 250° C. or less. For example, in this step, heat curing may be performed at less than 250° C., less than 230° C., or less than 210° C. The present application may provide a polyimide with improved transparency, eco-friendliness, and storage stability by thermally curing the polyamic acid prepared using the aqueous mixed solvent and the aqueous catalyst.

The present application also relates to a polyimide. The polyimide may be derived from the aqueous polyamic acid composition described above. The polyimide may be applied to various electrical and electronic materials to which polyimide films are applied, such as transparent display substrates or covers.

### Advantageous Effects

The aqueous polyamic acid composition according to the present application enables the polymerization of polyamic acid from hydrophobic monomers in water and can be used to prepare a polyimide with improved transparency, eco-friendliness, and storage stability upon curing.

### BRIEF DESCRIPTION OF DRAWINGS

FIG. 1 is a graph showing the surface tension of an aqueous mixed solvent according to the content of various polar solvents.

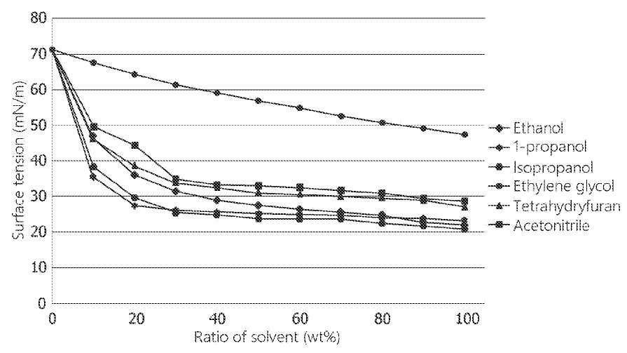

### BEST MODE

Hereinafter, the present application will be described more in detail by way of examples according to the present application, but the scope of the present application is not limited to the following examples.

### Example 1

87.7 g of distilled water and 29.78 g of 1-propanol (molar ratio 9:1) were added as solvents to a reactor equipped with a temperature controller and filled with nitrogen. 6.4048 g (0.02 mol) of 2,2′-bis[trifluoromethyl]benzidine (TFMB) and 6.1085 g (1.25 equivalents relative to the carboxyl group) of 4-dimethylaminopyridine were added thereto, and then the mixture was dissolved using a mechanical stirrer for 1 hour at 25° C. Thereafter, 8.8848 g (0.02 mol) of 4,4′-(hexafluoroisopropylidene)diphthalic anhydride (6FDA) was added, and the mixture was stirred at 70° C. for 6 hours and polymerized to prepare water-soluble polyamic acid.

Thereafter, the obtained aqueous polyamic acid was cast on a glass substrate using a bar coater, dried in a vacuum oven at 40° C. for 2 hours, and then thermally imidized stepwise at 100° C. for 30 minutes, 150° C. for 30 minutes, and 200° C. for 30 minutes to prepare a polyimide film with a thickness of 25 μm.

Hereinafter, various aqueous polyamic acid compositions and polyimide films of the Examples and Comparative Examples were prepared in the same manner as Example 1 according to the compositions shown in Table 1 (however, the content of the aqueous catalyst added in the Examples and Comparative Examples was 1.25 equivalents respect to the carboxyl group).

TABLE 1

| | Composition of aqueous polyamic acid | | | | | | | | |
|---|---|---|---|---|---|---|---|---|---|
| | | | | | Polymerization | Polymerization | Solid | Solution | |
| | | | Aqueous | | temperature | time | content | Viscosity | Inherent |
| | Dianhydride | Diamine | Catalyst | Solvent | (° C.) | (h) | (wt %) | (cps) | Viscosity |
| Example 1 | 6FDA | TFMB | DMAP | H₂O:1-P = 9:1 | 70 | 6 | 18 | 7213 | 0.53 |
| Example 2 | 6FDA | TFMB | DMAP | H₂O:1-P = 7:3 | 70 | 6 | 20 | 6962 | 0.71 |
| Example 3 | 6FDA | TFMB | DMAP | H₂O:1-P = 5:5 | 70 | 6 | 25 | 7382 | 0.90 |
| Example 4 | BPADA | TFMB | DMAP | H₂O:1-P = 9:1 | 70 | 6 | 10 | 9081 | 0.60 |
| Example 5 | BPADA | TFMB | DMAP | H₂O:1-P = 7:3 | 70 | 6 | 13 | 7382 | 0.77 |
| Example 6 | BPADA | TFMB | DMAP | H₂O:1-P = 5:5 | 70 | 6 | 15 | 8733 | 0.87 |
| Example 7 | HPMDA | TFMB | DMAP | H₂O:1-P = 9:1 | 70 | 6 | 8 | 1559 | 0.45 |
| Example 8 | HPMDA | TFMB | DMAP | H₂O:1-P = 7:3 | 70 | 6 | 10 | 3462 | 0.46 |
| Example 9 | HPMDA | TFMB | DMAP | H₂O:1-P = 5:5 | 70 | 6 | 12 | 2369 | 0.36 |
| Example 10 | 6FDA | TFMB | DMAP | H₂O:2-P = 9:1 | 50 | 6 | 15 | 8505 | 0.79 |
| Example 11 | 6FDA | TFMB | DMAP | H₂O:EtOH = 5:5 | 40 | 6 | 17 | 10530 | 0.74 |
| Example 12 | 6FDA | TFMB | DMAP | H₂O:MeCN = 5:5 | 50 | 6 | 15 | 9303 | 0.62 |
| Example 13 | 6FDA | TFMB | DMAPN | H₂O:1-P = 5:5 | 70 | 6 | 17 | 5646 | 0.70 |
| Example 14 | 6FDA | TFMB | TMPDA | H₂O:1-P = 5:5 | 70 | 6 | 13 | 4450 | 0.69 |
| Comparative | 6FDA | TFMB | DMAP | H₂O | 70 | 12 | 10 | Uniform | |
| Example 1 | | | | | | | | solution is | |
| | | | | | | | | not prepared | |
| Comparative | 6FDA | TFMB | DMAP | H₂O:EtOH = 9:1 | 40 | 6 | 12 | Uniform | |
| Example 2 | | | | | | | | solution is | |
| | | | | | | | | not prepared | |
| Comparative | 6FDA | TFMB | DMAP | H₂O:EG = 2:8 | 70 | 6 | 15 | Uniform | |
| example 3 | | | | | | | | solution is | |
| | | | | | | | | not prepared | |
| Comparative | 6FDA | TFMB | DMAP | NMP (Organic | 25 | 24 | 15 | 16500 | 1.21 |
| Example 4 | | | | solvent) | | | | | |

6FDA: 4,4′-(2,2-Hexafluoroisopropylidene)diphthalic dianhydride
BPADA: 2,2-Bis((3,4-dicarboxyphenoxy)phenyl)propane dianhydride
HPMDA: 1,2,4,5-Cyclohexane tetracarboxylic dianhydride
TFMB: 2,2′-Bis(trifluoromethyl)benzidine
DMAP: 4-Dimethylaminopyridine
DMAPN: 3-Methylaminopropionitrile
TMPDA: N,N,N′,N′-tetramethyl-1,3-propanediamine
1-P: 1-Propanol
2-P: Isopropanol
EtOH: Ethanol

Comparative Example 1 is an example of the polymerization of polyamic acid in a 100% aqueous solvent. In Comparative Examples 2 and 3, polyamic acid was not polymerized from fluorine monomers because the surface tension of the mixed solution was high. Comparative Example 4 is an example of the polymerization of polyamic acid in an organic solvent. On the other hand, in Examples 1 to 14, polymerization was possible in an aqueous mixed solvent.

### 1. Solution Viscosity Measurement

For the polyamic acid compositions prepared in the Examples and Comparative Examples, viscosity was measured at a shear rate of 30/s, a temperature of 25° C., and a plate gap of 1 mm using a VT-550 manufactured by Haake GmbH, and the results are shown in Table 1 above.

### 2. Inherent Viscosity

The polyamic acid compositions prepared in the Examples and Comparative Examples was diluted to a concentration of 0.5 g/dl (solvent:water) based on the solid content concentration. The flow time (T₁) of the diluted solution was measured using a Cannon-Fenske viscometer No. 100 at 30° C. Inherent viscosity was calculated using the flow time (T₀) of blank water using the following equation, and the results are shown in Table 1 above.

$$Inherent viscosity = \{ ln ( {T}_{1} / {T}_{0} ) \} / 0.5$$

### 3. Light Transmittance

For the aqueous polyamic acids of some Examples and Comparative examples, light transmittance was measured using BYK-Gardner's Haze-gard plus according to the ASTM D1003:11 standard, and the results are shown in Table 2.

### 4. Yellowness

For the aqueous polyamic acids of some Examples and Comparative examples, the yellowness index (YI) was measured using a colorimeter (MINOLTA, CM-3700d(d/8°)), and the results are shown in Table 2.

### 5. Glass Transition Temperature

For the polyimide films of some Examples and Comparative examples, the glass transition temperature of the film was measured using dynamic mechanical analysis equipment (DMA, TA instrument, Q800) under a nitrogen atmosphere at a temperature range of 30 to 380° C. and a temperature increase rate of 5° C./min, and the results are shown in Table 2.

TABLE 2

| | Polyimide film | | |
|---|---|---|---|
| | | Light | Glass transition |
| | | transmittance | temperature |
| | Yellowness | (%) | (° C.) |
| Example 3 | 1.43 | 92.7 | 348 |
| Example 4 | 1.52 | 91.9 | 332 |
| Example 6 | 1.58 | 92.0 | 340 |
| Example 7 | 2.3 | 87.2 | 243 |
| Example 9 | 1.5 | 91.1 | 355 |
| Comparative Example 4 | 2.0 | 90 | 340 |

1. An aqueous polyamic acid composition comprising: polyamic acid including a diamine monomer and a dianhydride monomer as polymerization units; an aqueous mixed solvent including water and a polar solvent and having a surface tension of 50 mN/m or less; and an aqueous catalyst.

2. The aqueous polyamic acid composition of claim 1, wherein the aqueous catalyst has a surface tension of 35 mN/m or less.

3. The aqueous polyamic acid composition of claim 1, wherein the polar solvent has at least one polar functional group selected from the group consisting of a hydroxyl group, a carboxyl group, an alkoxy group, an ester group, an ether group, and a nitrile group.

4. The aqueous polyamic acid composition of claim 1, wherein the polar solvent includes ethanol, 1-propanol, isopropanol, tetrahydrofuran, or acetonitrile.

5. The aqueous polyamic acid composition of claim 1, wherein the polar solvent is included in an amount of 10% by weight or more based on the total content of the aqueous mixed solvent.

6. The aqueous polyamic acid composition of claim 1, wherein the aqueous catalyst is a pyridine derivative compound or a tertiary amine having at least one substituent.

7. The aqueous polyamic acid composition of claim 6, wherein the pyridine derivative compound satisfies Chemical Formula 1 below: 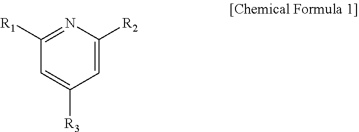
in Chemical Formula 1, at least one of R₁ to R₃ is an alkylamine group, a hydroxyl group, an alkoxy group, a thiol group, a thiol ether group, an alkyl group, or a heterocyclic group.

8. The aqueous polyamic acid composition of claim 6, wherein the pyridine derivative compound satisfies Chemical Formula 2 below: 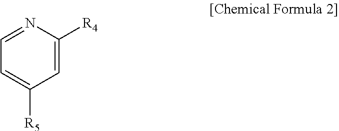
in Chemical Formula 2, at least one of R₄ and R₅ is a monoalkylamino group having 1 to 4 carbon atoms, a dialkylamino group having 1 to 4 carbon atoms, a hydroxyl group, an alkoxy group having 1 to 4 carbon atoms, a thiol group, a thiol ether group having 1 to 4 carbon atoms, an alkyl group having 1 to 4 carbon atoms, a piperidino group, a morpholino group, or a pyrrolidino group.

9. The aqueous polyamic acid composition of claim 6, wherein the tertiary amine having at least one substituent satisfies Chemical Formula 3 below: 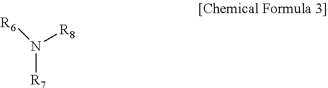
in Chemical Formula 3, R₆ to R₈ are a substituted or unsubstituted alkyl group,
at least one of R₆ to R₈ is a substituted alkyl group, and
the substituted alkyl group includes at least one substituent selected from the group consisting of cyano, a halogen, hydroxy, alkoxy, thiol, sulfide, sulfoxide, alkylamide, phosphate, carboxy, carbonyl, and ester.

10. The aqueous polyamic acid composition of claim 1, wherein the aqueous catalyst is in the range of 0.1 to 2 times equivalent based on 1 equivalent of a carboxyl group in the polyamic acid.

11. The aqueous polyamic acid composition of claim 1, wherein the dianhydride monomer includes at least one compound represented by Chemical Formula 4 below: 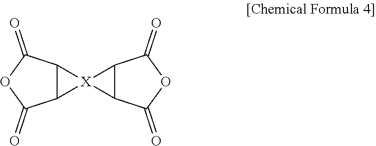
in Chemical Formula 4, X is a substituted or unsubstituted tetravalent aliphatic ring group, a substituted or unsubstituted tetravalent heteroaliphatic ring group, a substituted or unsubstituted tetravalent aromatic ring group, or a substituted or unsubstituted tetravalent heteroaromatic ring group, and
the aliphatic ring group, the heteroaliphatic ring group, the aromatic ring group, or the heteroaromatic ring group is present singly;
joined together to form a condensed ring; or
linked by a linking group including one or more of divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)²—, and —Si(Rₐ)₂—, wherein Rₐ is hydrogen or an alkyl group.

12. The aqueous polyamic acid composition of claim 11,
wherein X is phenyl, biphenyl, 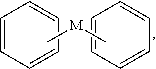
or an aliphatic ring group, and
M includes at least one selected from the group consisting of a single bond, an alkylene group, an alkylidene group, —O—, —S—, —C(═O)—, and —S(═O)₂—, and is substituted with at least one substituent including fluorine and an alkyl group or unsubstituted.

13. The aqueous polyamic acid composition of claim 1, wherein the diamine monomer includes at least one compound represented by Chemical Formula 5 below: 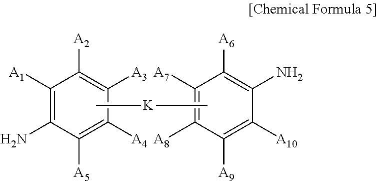
in Chemical Formula 5, K is a linking group including one or more of divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)₂—, and —Si(Rₐ)₂—, and A₁ to A₁₀ each independently represent hydrogen; a halogen; a hydroxyl group; a carboxyl group; or an alkyl group substituted with a halogen or unsubstituted, and
at least one of K and A₁ to A₁₀ has an alkyl group substituted with fluorine in its structure.

14. The aqueous polyamic acid composition of claim 1, wherein the diamine monomer includes at least one compound represented by Chemical Formula 6 below: 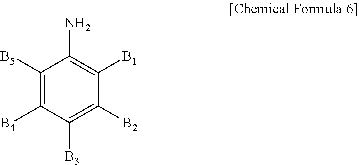
in Chemical Formula 6, any one of B₁ to B₅ is an amino group, and the others are hydrogen; a halogen; a hydroxyl group; a carboxyl group; or a halogen-substituted or unsubstituted alkyl group, and
at least one of B₁ to B₅ has an alkyl group substituted with fluorine in its structure.

15. The aqueous polyamic acid composition of claim 1, wherein a cured product of the aqueous polyamic acid composition has a light transmittance to visible light in the range of 80% to 99%.

16. The aqueous polyamic acid composition of claim 1, wherein a cured product of the aqueous polyamic acid composition has a yellowness in the range of 0.5 to 2.5.

17. The aqueous polyamic acid composition of claim 1, wherein a cured product of the aqueous polyamic acid composition has a glass transition temperature in the range of 200 to 450° C.
